(19) United States
(12) Patent Application Publication
(10) Pub. No.: US 2010/0085742 A1
(43) Pub. Date: Apr. 8, 2010

(54) Solar powered garden light with rotatable direction indicating lights

(76) Inventor: Ken Ip, Kowloon (HK)

Correspondence Address: ERIC HANSCOM, 7395 PORTAGE WAY, CARLSBAD, CA, 92011, US

(21) Appl. No.: 12/246,404

(22) Filed: Oct. 6, 2008

(51) Int. Cl. F21L 4/00

(52) U.S. Cl. 362/183

(57) ABSTRACT

A solar powered garden light that can be used to indicate a direction is disclosed. LEDs are situated in a pattern, such as an arrow, on a platform which can be rotated. A user can adjust the direction that the solar powered garden light indicates by rotating the platform. The platform can be rotated by turning a knob. A solar cell is used to charge batteries, where these batteries are used to power the LEDs. The same solar cell can also act as a switch that turns the lights on and off.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

Field of the invention: This invention relates to the general field of garden lights, and more specifically toward a solar powered garden light that can be used to indicate a direction. LEDs are situated in a pattern, such as an arrow, on a platform which can be rotated. A user can adjust the direction that the solar powered garden light indicates by rotating the platform. The platform can be rotated by turning a knob. A solar cell is used to charge batteries, where these batteries are used to power the LEDs. The same solar cell can also act as a switch that turns the LEDs on and off.

There are many gardens around the world that are meticulously well kept with many varieties of vegetation. People absorb the natural beauty and find comfort in the serene surroundings. Impressively large trees can be right next to small delicate plants. Gardens themselves can be massive in size, taking up many city blocks, or just a few square feet near a person's home. In any circumstance, once the sun goes down, these gardens are often bathed in darkness.

To combat this darkness, people have placed lights in their gardens, which can often have a dramatic effect. Further, signs have also been used in gardens to indicate particular directions or paths to those in the garden. These signs have been illuminated by external signs or the signs themselves produce light internally. However, these lights are often connected to an external power supply and consume relatively large amounts of energy. Further, users do not have the ability to easily change the direction indicated by the signs.

The prior art has failed to solve these issues in an efficient and inexpensive manner. Large solar-powered signs employing a large matrix of LEDs have been taught to convey messages to viewers. These signs, while solar powered, are large and require complex circuits to create and display information. They are not small and aesthetically pleasing and are thus not appropriate for use in gardens.

Small solar powered garden lights that use LEDs for producing light are known in the art. These have been used to light paths as well as convey information to users. These small solar powered lights, while able to indicate information to a user such as direction, the information is not easily changed. For example, if there is a small garden light with an arrow pointing left, prior to the current invention, the same light could not be subsequently used to have an illuminated arrow point to the right.

Previously, solar powered garden lights have used solar cells to power batteries and a separate light sensor to turn the garden light on and off. The light sensor is an added expense as well as an additional point of failure; if the light sensor does not work, the solar powered garden light will not turn on.

Thus there has existed a long-felt need for a solar powered garden light that can indicate a direction. The direction should be easily changed such that the same solar powered garden light can be used to indicate a variety of directions. Additionally, the solar powered garden light should include as few parts as possible to increase efficiency and reliability as well as to reduce the cost of manufacturing the device.

The current invention provides just such a solution by having a solar powered garden light that can be used to indicate a direction. LEDs are situated in a pattern, such as an arrow, on a platform which can be rotated. A user can adjust the direction that the solar powered garden light indicates by rotating the platform. The platform can be rotated by turning a knob. A solar cell is used to charge batteries, where these batteries are used to power the LEDs. The same solar cell can also act as a switch that turns the LEDs on and off.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

The invention includes six major components, the combination and configuration of which leads to a new and novel solar powered garden light. An LED circuit board that acts as a platform includes a plurality of LEDs. When the LEDs are illuminated, they emit light through a transparent or translucent lens. A solar panel produces electrical energy from light and also acts as a switch. A control circuit manages the operation of the solar powered garden light. The LED circuit board is rotated by turning a knob, where the knob is connected to the LED circuit board by shafts and, optionally, gears. Finally, these components are housed in an enclosure, where this enclosure includes a pole and a ground spike to secure the device into the ground.

It is a principal object of the invention to provide a solar powered garden light that can indicate a direction to a viewer.

It is another object of the invention to provide a solar powered garden light where the direction that is indicated by the device can quickly and easily be changed to a different direction without removing the device from the ground.

It is a final object of this invention to provide a solar powered garden light that is inexpensive to manufacture as well as reliable.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is an exploded view of the solar powered garden light.

FIG. 2 is a perspective view of the solar powered garden light.

FIG. 3 is a perspective view of an alternative embodiment of the solar powered garden light.

FIG. 4 is a circuit diagram of the electrical devices and connections employed in the solar powered garden light.

### DETAILED DESCRIPTION OF THE FIGURES

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

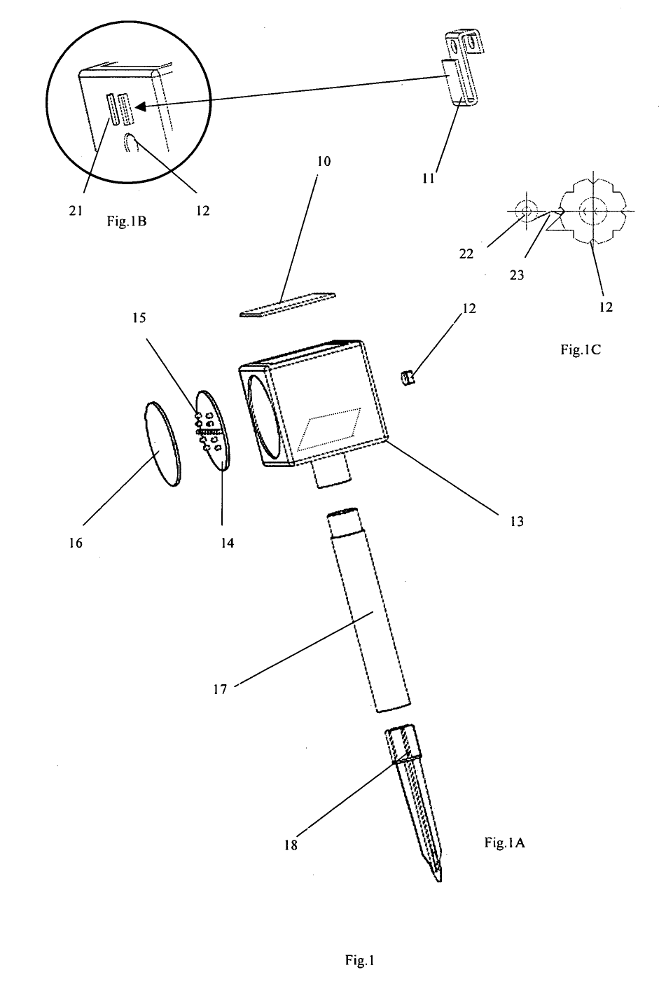

FIG. 1, and specifically FIG. 1A, is an exploded view of the solar powered garden light. An enclosure 13 is used to house the major components of the current invention. On the top of the enclosure 13 is a solar panel 10 that is used to collect light and produce an electrical current to power the electrical components of the solar powered garden light. The electrical current from the solar panel 10 is used to power an LED circuit board 14, which in turn can cause LEDs 15 to emit light. A lens 16 is placed over the LEDs 15 and LED circuit board 14 to protect these elements. The lens 16 can be transparent or translucent. Fogged or etched glass is an example of a translucent lens that can be used with the current invention. A knob 12 is connected to the LED circuit board 14 by shafts, gears, or both, and can be used to rotate the LED circuit board 14. The LED circuit board 14 therefore acts as a rotating platform that can be rotated to change the orientation of the LEDs 15. If the LEDs are arrayed into an arrow pattern, then the direction that the arrow points can be changed by turning the knob 12 which in turn causes the LED circuit board 14 to rotate.

The enclosure 13 itself can be mounted on top of a pole 17, where the pole can be attached to a ground spike 18 that is used to secure the pole 17 and the rest of the solar powered garden light in the ground. The back side of the enclosure 13 can also include a bracket attachment 21 that attaches a bracket 11 to the enclosure 13. In this embodiment, the bracket attachment 21 is located directly above the knob 12. The bracket 11 can be used to secure the solar powered garden light to another object, such as a fence or other sign, instead of using the pole 17 and ground spike 18.

FIG. 1C is a detailed view of the knob 12. The knob 12 is prevented from rotating more than 360 degrees by a rotation prevention arm 22. The knob 12 includes an extension that extends beyond the normal circumference of the knob 12. The knob 12 is prevented from rotating when the extension 23 comes in contact with the rotation prevention arm 22. The knob 12 can also contain grooves about its circumference where the rotation prevent arm 22 fits into, thereby causing the knob 12, and therefore the rotating platform, to remain at a set rotational angle until changed by a user. In an alternative embodiment, the knob itself is round but attached to a gear that has the same characteristics as the knob shown in FIG. 1C. That gear would then prevent the knob from rotating when the gear's extension comes in contact with the rotation prevention arm 22. The gear and rotation prevention arm 22 would then preferably be located within the enclosure.

It is also possible to control the rotation of the LED circuit board by an electric motor. This motor can be powered by the solar panel, batteries, or both. The electric motor can be controlled directly, such as by turning a switch on or off. Alternatively, other means commonly known in the art, such as remote controls utilizing radio waves, can control the rotation of the rotational platform. In this manner, a multiplicity of solar powered garden lights can be controlled simultaneously to change the direction that the solar powered garden light indicates.

A multiple number of garden lights can also be connected together. This allows the solar powered garden lights to flash in sequence. For example, a plurality of solar powered garden lights could be connected together by means of cables. These cables connect to circuits of the solar powered garden lights such that each solar powered garden light flashes in sequence with the other. Therefore, solar powered garden lights placed along a path can direct visitors down a path by not only following the direction indicated by each garden light, but also by the sequence of lights that travels along the path. This same cable can also be used to simultaneously rotating the rotating platform of each solar powered garden light along with changing the sequence that the solar powered garden lights flash, thereby reversing the direction indicated by the solar powered garden lights. While the means of connecting the solar powered garden lights has been disclosed using cables, it is nonetheless possible to achieve the same result through the use of wireless means. Each solar powered garden light can communicate with the other lights to flash their LEDs in sequence or to rotating the rotating platform at the same time.

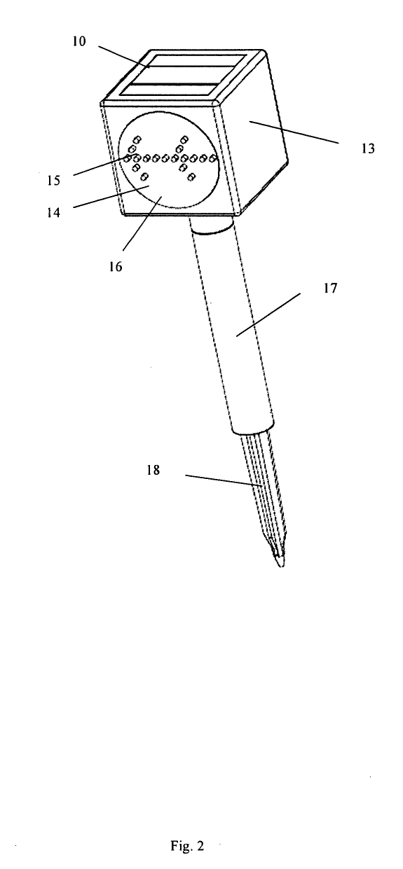

FIG. 2 is a perspective view of the solar powered garden light. A solar panel 10 is located on the top of an enclosure 13. LEDs 15 are attached to an LED circuit board 14 which acts as a rotating platform. A lens 16 is located over the LEDs 15 and LED circuit board 14. The enclosure 13 is attached to a pole 17, which in turn is attached to a ground spike 18 that secures the solar powered garden light to the ground.

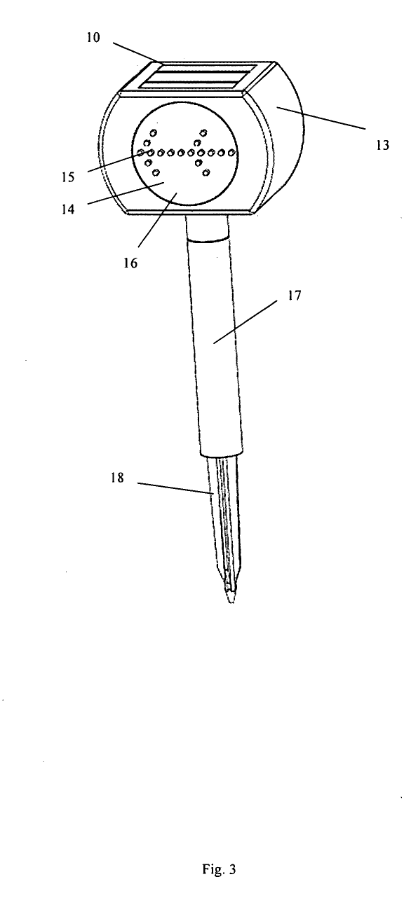

FIG. 3 is a perspective view of an alternative embodiment of the solar powered garden light. A solar panel 10 is located on the top of an enclosure 13. LEDs 15 are attached to an LED circuit board 14 which acts as a rotating platform. A lens 16 is located over the LEDs 15 and LED circuit board 14. The enclosure 13 is attached to a pole 17, which in turn is attached to a ground spike 18 that secures the solar powered garden light to the ground. However, in this embodiment, the enclosure itself is in a semi-elliptical shape.

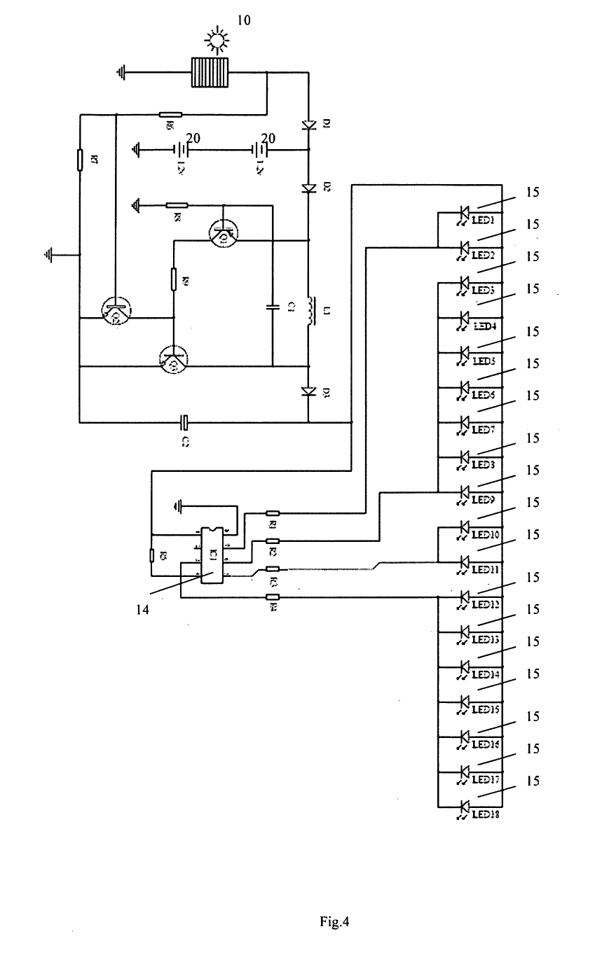

FIG. 4 is a circuit diagram of the electrical devices and connections employed in the solar powered garden light. A solar panel 10 is used to transform light into electrical energy. This electrical energy can be stored in batteries 20. The solar panel 10 can also be used as a switch to turn LEDs 15 on and off. When it is dark, the solar panel 10 will no longer produce a sufficient amount energy since a minimal amount of light is incident upon the solar panel 10. The circuit will then cause the batteries 20 to provide an electrical current to the LEDs 15 causing them to produce light. However, when there is an abundance of light incident upon the solar panel 10, it will cause the circuit to no longer provide power to the LEDs 15, thereby turning them off. In this manner, the solar panel 10 can act as a switch to turn the LEDs 15 on and off. The LED circuit board 14 controls the LEDs and can cause the LEDs to flash or glow in sequence or randomly.

For example, during the day time, the solar panel 10 will transform light into an electrical current that is used to power the batteries 20. As day turns to night, the amount of light incident upon the solar panel 10 decreases and eventually reaches a point that causes the circuit to power the LEDs 15. Since there is generally insufficient electrical energy produced by the solar panel 10 to power the LEDs 15 at night, the batteries 20 are mainly used to power the LEDs. When night turns to day, the solar panel 10 once again is able to produce electrical energy. This can cause the LEDs 15 to turn off and for the electrical current form the solar panel 10 to once again charge the batteries 20.

What I claim is:

1. A solar powered garden light comprising
an enclosure, a solar panel, a rotating platform, a means for rotating the rotating platform, a battery, and a source of light,
where the solar panel is able to transform light into electrical energy, where this energy can be stored in the battery, used to power the source of light, or both, where the solar panel is located on the surface or externally to the enclosure,
where the source of light is attached to the rotating platform, where the source of light can be powered by the solar panel, battery, or both, where the source of light, when powered, emits light, where the source of light indicates a direction when illuminated, where the direction indicated by the source of light changes when the rotational platform is rotated.

2. The solar powered garden light of claim 1, where the rotating platform comprises a circuit board.

3. The solar powered garden light of claim 2, where the source of light is a plurality of LEDs.

4. The solar powered garden light of claim 3, where the battery, the solar panel, or both can power the circuit board, where the circuit board then powers the plurality of LEDs.

5. The solar powered garden light of claim 4, where the circuit board causes the plurality of LEDs to flash or glow randomly or in sequence.

6. The solar powered garden light of claim 3, where the plurality of LEDs is in the shape of one or more arrows.

7. The solar powered garden light of claim 1, where the solar panel also acts as a switch, where the switch is used to turn the source of light on and off.

8. The solar powered garden light of claim 7, where the switch is designed to turn the source of light on when there is a minimal amount of light incident upon the solar panel, and turn the source of light off when there is an abundant amount of light incident upon the solar panel.

9. The solar powered garden light of claim 1 further comprising a lens, where the light emitted from the source of light travels through the lens, where the lens is transparent or translucent.

10. The solar powered garden light of claim 1, where the rotating platform is rotated by turning a knob.

11. The solar powered garden light of claim 1, where the solar powered garden light comprises a plurality of batteries.

12. The solar powered garden light of claim 1, where the enclosure further comprises a pole and a ground spike, where the enclosure is mounted on a pole, where the pole is attached to a ground spike, where the ground spike secures the pole, and therefore enclosure, to the ground.

13. The solar powered garden light of claim 1, where the enclosure further comprises a bracket, where the enclosure is secured to the bracket, and where the bracket can be secured to another object thereby mounting the enclosure to another object.

14. A solar powered garden light comprising
an enclosure, a solar panel, a rotating platform, a means for rotating the rotating platform, a battery, and a plurality of LEDs,
where the solar panel is able to transform light into electrical energy, where this energy can be stored in the battery, used to power the source of light, or both, where the solar panel is located on the surface or externally to the enclosure,
where the rotating platform comprises a circuit board, where the plurality of LEDs is attached to the rotating platform, where the battery, the solar panel, or both can power the circuit board, where the circuit board then powers the plurality of LEDs, where the plurality of LEDs, when powered, emits light, where the plurality of LEDs indicates a direction when illuminated, where the plurality of LEDs indicates a direction when illuminated, where the direction indicated by the plurality of LEDs changes when the rotational platform is rotated.

15. The solar powered garden light of claim 14, where the solar panel also acts as a switch, where the switch is used to turn the plurality of LEDs on and off, where the switch is designed to turn the plurality of LEDs on when there is a minimal amount of light incident upon the solar panel, and turn the plurality of LEDs off when there is an abundant amount of light incident upon the solar panel.

16. The solar powered garden light of claim 14 further comprising a lens, where the light emitted from the plurality of LEDs travels through the lens, where the lens is transparent or translucent.

17. The solar powered garden light of claim 14, where the rotating platform is rotated by turning a knob.

18. The solar powered garden light of claim 14, where the plurality of LEDs is in the shape of one or more arrows.

19. A solar powered garden light consisting essentially of
an enclosure, one or more solar panels, a rotating platform, a means for rotating the rotating platform, one or more batteries, a plurality of LEDs, a lens, and a means for securing the enclosure to the ground or another object,
where the one or more solar panels is able to transform light into electrical energy, where this energy can be stored in the one or more batteries, used to power the plurality of LEDs, or both, where the one or more solar panels is located on the surface or externally to the enclosure,
where the rotating platform comprises a circuit board, where the plurality of LEDs is attached to the rotating platform, where the one or more batteries, the one or more solar panels, or both can power the circuit board, where the circuit board then powers the plurality of LEDs, where the plurality of LEDs, when powered, emits light, where the plurality of LEDs indicates a direction when illuminated, where the direction indicated by the plurality of LEDs changes when the rotational platform is rotated,
where the one or more solar panels also acts as a switch, where the switch is used to turn the source of light on and off,
where the light emitted from the plurality of LEDs travels through the lens, where the lens is transparent or translucent
where the means for rotating platform comprises a knob, and where the rotating platform is rotating by turning the knob.

20. The solar powered garden light of claim 3, where the plurality of LEDs is in the shape of one or more arrows.
